(19) United States
(12) Patent Application Publication
(10) Pub. No.: US 2024/0266780 A1
(43) Pub. Date: Aug. 8, 2024

(54) SURFACE TREATMENT FOR ADHESION OF ELECTRICAL TERMINALS AND METHOD OF FORMING

(71) Applicant: Steering Solutions IP Holding Corporation, Saginaw, MI (US)

(72) Inventors: David M. Williams, Millington, MI (US); Matt Jimkoski, Freeland, MI (US)

(21) Appl. No.: 18/422,222

(22) Filed: Jan. 25, 2024

Related U.S. Application Data
(60) Provisional application No. 63/443,663, filed on Feb. 6, 2023.

(51) Int. Cl. H01R 13/52; H01R 43/16

(52) U.S. Cl. CPC H01R 13/521; H01R 43/16; H01R 2201/26

(57) ABSTRACT

An electrical terminal assembly for a vehicle electrical connector assembly includes a header. The electrical terminal assembly also includes a potting material disposed within a cavity of the header. The electrical terminal assembly further includes an electrical terminal extending through the header and the potting material, the electrical terminal formed of metal and having a non-uniform outer surface including at least one engagement feature for adhering to the header and the potting material.

### CROSS-REFERENCE TO RELATED APPLICATION

This application claims the benefits of priority to U.S. Provisional Patent Application Ser. No. 63/443,663, filed Feb. 6, 2023, the disclosure of which is incorporated by reference herein in its entirety.

### FIELD OF THE INVENTION

The embodiments described herein relate to electrical terminals and, more particularly, to a surface treatment for improved adhesion of electrical terminals.

### BACKGROUND

A vehicle, such as a car, truck, sport utility vehicle, crossover, mini-van, marine craft, aircraft, all-terrain vehicle, recreational vehicle, or other suitable vehicles, typically include various electric motor-vehicle interface locations. Electric motors may be used throughout the vehicle for a variety of functions, such as power steering, steering column adjustment, and other functionalities. These motors typically receive instructions from a circuit board assembly that facilitates the motor-vehicle interface. Circuit boards (e.g., a printed circuit board) locate and connect various electronic components and thus design and packaging considerations are important for end use.

A powerpack is a common structure for a variety of electrical connections and is used to provide commands to steering column components. Water ingress into the powerpack controller through an electrical harness header results in failure so vehicle manufacturers may specify requirements to eliminate this failure. For example, requirements may involve a primary requirement of a sealed connector with the secondary/backup requirement being potting over the front side and/or the back side of the connector. Various methods to determine if the potting has sealed the connection area may be run. Historically, this has been problematic due to a lack of adhesion between the electrical terminal and the potting, resulting in scrapped powerpacks. A failed test can be significantly costly in this respect. FIG. 1 shows an example of an electrical connector potentially suffering from the issues discussed above.

### SUMMARY

According to one aspect of the disclosure, an electrical terminal assembly for a vehicle electrical connector assembly includes a header. The electrical terminal assembly also includes a potting material disposed within a cavity of the header. The electrical terminal assembly further includes an electrical terminal extending through the header and the potting material, the electrical terminal formed of metal and having a non-uniform outer surface including at least one engagement feature for adhering to the header and the potting material.

According to another aspect of the disclosure, an electrical terminal extending through a component of a vehicle electrical steering system is provided. The electrical terminal includes a cylindrical body. The electrical terminal also includes a plurality of engagement features protruding from the cylindrical body and in direct contact with a surrounding portion of the component, wherein the plurality of engagement features comprises a first set of engagement features and a second set of engagement features.

According to another aspect of the disclosure, a method of forming an electrical terminal is provide. The method includes providing a blank material having a constant cross-section along its length. The method also includes forming a plurality of engagement features on an outer surface of the electrical terminal with an extended dual laser interference patterning (xDLIP) process.

These and other advantages and features will become more apparent from the following description taken in conjunction with the drawings.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a sectional view of an electrical terminal according to a prior art design;

FIG. 2 is a sectional view of an electrical terminal according to one aspect of the disclosure;

FIG. 3 is a side view of the electrical terminal installed in an electrical assembly; and

FIG. 4 is a front view of the electrical terminal installed in the electrical assembly.

### DETAILED DESCRIPTION

The following discussion is directed to various embodiments of the disclosure. Although one or more of these embodiments may be discussed and/or illustrated in more detail than others, the embodiments disclosed should not be interpreted, or otherwise used, as limiting the scope of the disclosure, including the claims. In addition, one skilled in the art will understand that the following description has broad application, and the discussion of any embodiment is meant only to be illustrative of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable vehicles, typically include various motor-vehicle interface locations. The motors described herein may be used throughout the vehicle for a variety of functions, such as power steering, steering column adjustment, and other functionalities. The electrically powered applications require circuit boards having a variety of electrical connections.

The embodiments disclosed herein provide a more robust electrical terminal for such connections. In particular, the embodiments of the electrical terminal improve the surface form of the metal terminal, the cleanliness of the terminal, and potentially the hydrophilicity of the terminal using extended dual laser interference patterning (xDLIP) or a similar process. These processes are quick and cost-effective methods for controlled and localized surface treatment of metal terminal surfaces, as xDLIP has the ability to contour and shape the surface of a metal terminal by using two different lasers. In addition to standard humps and/or grooves, it is possible to make sawtooth type shapes on the connection, providing a directional differential to the coefficient of friction and holding force. With the ability to sawtooth the surface, the surface area and geometry can be optimized for push and pull requirements, as well as surface adhesion.

Referring now to FIG. 1, prior designs have minimal or no engagement features in the components which the electrical terminals are installed within. As shown, the substantially straight, planar, or cylindrical geometry of the electrical terminal 10 does not engage the component 12 in any meaningful way. When attaching such a flat, or cylindrical, terminal to surrounding components, it is difficult to get consistent adhesion. The surface is non-uniform with different roughness.

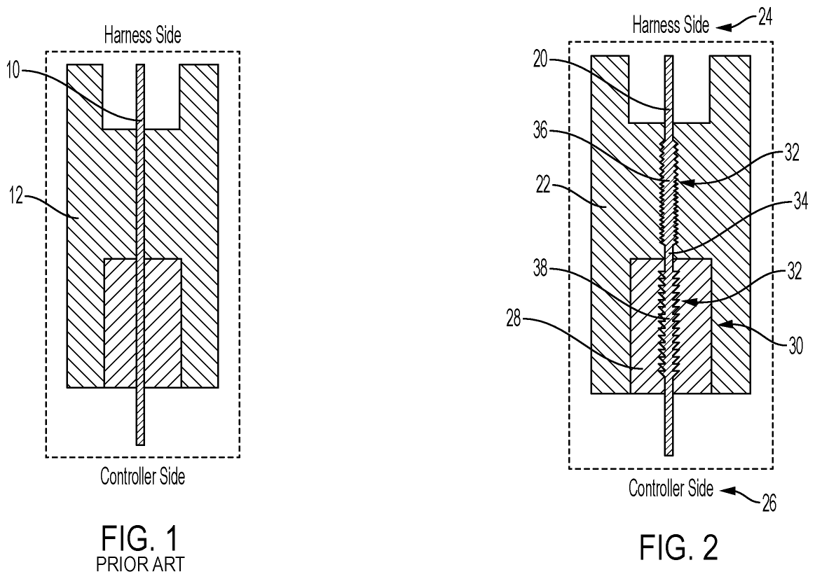

As shown in FIG. 2, an electrical terminal 20 is shown extending through a header 22. In some embodiments, the header 22 is part of a powerpack assembly in a vehicle steering system, but other applications of use are contemplated. The electrical terminal 20 extends from a harness side 24 of the header 22 to a controller side 26 of the header 22 for connection to a controller (not shown). The header 22 is formed of plastic in some embodiments. The electrical terminal 20 extends through the header 22 and through a potting material 28 which is disposed within a cavity 30 of the header 22. Although the potting material 28 is illustrated on the controller side of the header 22 in the illustrated embodiment, it is to be appreciated that the potting material 28 may be disposed on the harness side of the header 22. The potting material 28 may be present on only one side of the header 22 or both sides, depending on which configuration is more advantageous for assembly and other concerns.

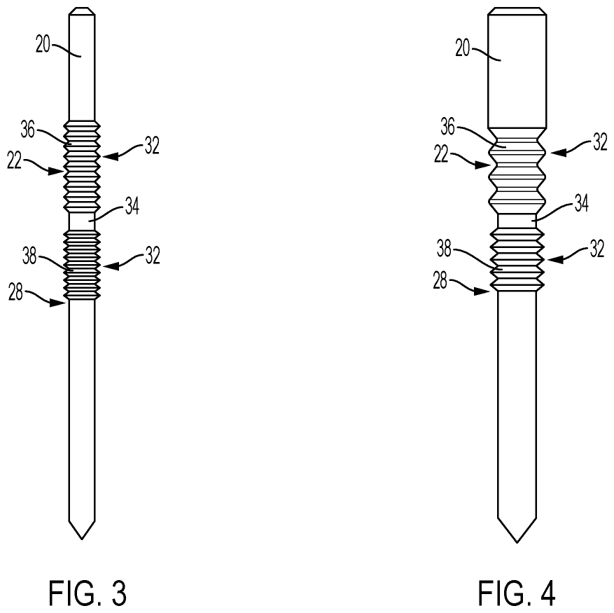

The surface of an electrical terminal 20 disclosed herein has engagement features 32 corresponding to interfacing contours of components which the electrical terminal 20 is installed within. FIGS. 3 and 4 show enlarged views of the electrical terminal 20 disposed within, and extending through, the header 22 and the potting material 28. The engagement features 32 disclosed herein refer to any surface contour or protrusion from the surface. The engagement features 32 may be in various shapes or dimensions. The engagement features 32 are identical in some embodiments and vary along the length of the electrical terminal 20 in other embodiments. For example, the engagement features 32 may be formed of one shape and/or size along the portion of the electrical terminal 20 directly engaged with the header 22 and formed of a different shape and/or size along the portion of the electrical terminal 20 directly engaged with the potting material 28. Any other variance of the engagement features 32 along the electrical terminal 32 is contemplated. Finally, uniformity of the engagement features 32 along an entire length of the electrical terminal 20 is present in some embodiments.

As shown, a space 34 between the engagement features 32 is present in some embodiments, particularly along a section of the electrical terminal 20 at the interface between the header 22 and the potting material 28. For example, a first set of engagement features 36 may be in direct engagement with a surrounding portion of the header 22 and a second set of engagement features 38 may be in direct engagement with a surrounding portion of the potting material 28. In such an embodiment, the first and second sets of engagement features 36, 38 are spaced from each other 34 with a portion of the electrical terminal 20 which does not have engagement features thereon. Therefore, the space portion 34 may be cylindrical and of constant cross-section.

Based on the electrical terminal 20 disclosed herein, both the interface of the electrical terminal 20 to the header 22 and the potting material 28 can be optimized, potentially independently for ideal adhesion and sealing purposes.

As described above in connection with the prior art electrical terminal 10 of FIG. 1, adhesion and sealing are a concern. The embodiments disclosed herein more approximate a screw rather than a nail based on the engagement features 32 being provided as a threaded arrangement, but it is to be understood that the screw-like threading is merely an example and other shapes or contours may be utilized, as described in detail above. By way of example, screws are much more robust to vertical loads (as done when pulling on a connector terminal or pushing air against a terminal to slide by), whereas nails bend under shear loads without breaking like a screw would. Engagement features 32 of other shapes or contours would also provide such characteristics. In some embodiments, the electrical terminal 20 may be modeled after #6-#12 silicone bronze screws having a pitch of 24 to 32 threads per inch. However, it is to be understood that pitch adjustment up or down may be made.

In addition to the engagement features 32 being utilized for holding forces, the surface of the terminal needs to have certain hydrophilic properties. This is because most silicon potting materials 28 utilize a moisture cure component and cure from the atmosphere in. If the surface of the electrical terminal 20 is devoid of moisture it will not cure quickly, if at all, as the curing agents in suspension move towards the moisture, not away from the electrical terminal 20.

In addition to the engagement features 20 being utilized for holding forces and hydrophilic purposes, there is also a thermal consideration. The electrical terminal 20 disclosed herein is soldered close to the potting material 28. Typical high reliability solder used in automotive (e.g., REL22) has a melting temperature of 210 degrees Celsius to 212 degrees Celsius. Such a temperature range results in the soldering iron or robot soldering these pins to have a temperature of about 215 degrees Celsius. Since the electrical terminal 20 is metal and with very high heat transfer, the heat will quickly go up the electrical terminal 20 into the potting material 28 adhesion area. Studies of interfacial bond strength on metal lead frames when subjected to elevated temperature show an estimated 75% reduction in joint adhesion in this range.

By providing engagement features 32 with the constant cross-section metal electrical terminal 20 some differential heat de-fusion into the material is experienced. This leaves some of the electrical terminal 20 adhesion points at a lower temperature able to achieve and maintain the higher adhesion. The shape of this will have to be balanced with other factors to achieve the best thermal cooling to allow for proper adhesion after the electrical thermal 20 soldering event. Different structures and shapes in metal ridges or pins etched into the electrical terminal 20 during the xDLIP process can be evaluated in conjunction with the other features.

In addition to the xDLIP step for formation of the engagement features 32, an additional laser etching process step cleans the electrical terminal 20. Plasma surface treatment is used to clean metals to provide better adhesion. xDLIP provides better adhesion properties since the laser gets hot enough to reform the surface metals, meaning organic and inorganic contaminants (e.g., oxide layers) will be drastically reduced through this process. While driving to full laser ablation may not be needed, some cleaning is expected to be accomplished in the forming of the ridges.

While the invention has been described in detail in connection with only a limited number of embodiments, it is to be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Moreover, any feature, element, component or advantage of any one embodiment can be used on any of the other embodiments. Accordingly, the invention is not to be seen as limited by the foregoing description.

What is claimed is:

1. An electrical terminal assembly for a vehicle electrical connector assembly comprising:
a header;
a potting material disposed within a cavity of the header; and
an electrical terminal extending through the header and the potting material, the electrical terminal formed of metal and having a non-uniform outer surface including at least one engagement feature for adhering to the header and the potting material.

2. The electrical terminal assembly of claim 1, wherein the engagement feature comprises a plurality of engagement features.

3. The electrical terminal assembly of claim 2, wherein the plurality of engagement features are uniformly shaped.

4. The electrical terminal assembly of claim 2, wherein the plurality of engagement features are non-uniformly shaped.

5. The electrical terminal assembly of claim 4, wherein the plurality of engagement features comprises a first set of engagement features and a second set of engagement features.

6. The electrical terminal assembly of claim 5, wherein the first set of engagement features are positioned in direct engagement with the header and the second set of engagement features are positioned in direct engagement with the potting material.

7. The electrical terminal assembly of claim 6, wherein the first set of engagement features and the second set of engagement features are separated by a portion of the electrical terminal without engagement features.

8. The electrical terminal assembly of claim 2, wherein the plurality of engagement features form a threading on the non-uniform outer surface of the electrical terminal.

9. The electrical terminal assembly of claim 1, wherein the at least one engagement feature is formed with an extended dual laser interference patterning (xDLIP) process.

10. The electrical terminal assembly of claim 1, wherein the electrical terminal assembly is disposed in a vehicle electrical system.

11. The electrical terminal assembly of claim 10, wherein the electrical terminal assembly is disposed in a vehicle electrical steering system.

12. The electrical terminal assembly of claim 1, wherein the header is formed of plastic.

13. An electrical terminal extending through a component of a vehicle electrical steering system, wherein the electrical terminal comprises:
a cylindrical body; and
a plurality of engagement features protruding from the cylindrical body and in direct contact with a surrounding portion of the component, wherein the plurality of engagement features comprises a first set of engagement features and a second set of engagement features.

14. The electrical terminal of claim 13, wherein the plurality of engagement features are uniformly shaped.

15. The electrical terminal of claim 13, wherein the plurality of engagement features are non-uniformly shaped.

16. The electrical terminal of claim 15, wherein the first set of engagement features and the second set of engagement features are separated by a portion of the electrical terminal without engagement features.

17. The electrical terminal of claim 13, wherein the plurality of engagement features form a threading on the non-uniform outer surface of the electrical terminal.

18. A method of forming an electrical terminal comprising:
providing a blank material having a constant cross-section along its length; and
forming a plurality of engagement features on an outer surface of the electrical terminal with an extended dual laser interference patterning (xDLIP) process.

19. The method of claim 18, further comprising cleaning the electrical terminal with a laser etching process.
